(19) United States
(12) Patent Application Publication
(10) Pub. No.: US 2007/0051812 A1
(43) Pub. Date: Mar. 8, 2007

(54) Method and apparatus employing imaging and/or scanning for reading machine-readable symbols such as barcode symbols

(75) Inventors: Christophe Lopez, St-Orens de Gameville (FR); Jean-Louis Massieu, Montauban (FR); Serge Thuries, Saint Jean (FR); Daniel B. Bodnar, Duvall, WA (US); H. Sprague Ackley, Everett, WA (US)

Correspondence Address: SEED INTELLECTUAL PROPERTY LAW GROUP PLLC, 701 FIFTH AVENUE, SUITE 6300, SEATTLE, WA, 98104-7092, US

(73) Assignee: Intermec IP Corp., Everett, WA (US)

(21) Appl. No.: 11/509,303

(22) Filed: Aug. 23, 2006

Related U.S. Application Data
(60) Provisional application No. 60/711,027, filed on Aug. 24, 2005.

(51) Int. Cl. G06K 7/10

(52) U.S. Cl. 235/454; 235/455; 235/462.41

(57) ABSTRACT

A machine-readable symbol reader is operable to read one and two-dimensional machine-readable symbols such as barcode or matrix code symbols. The reader includes an imaging subsystem and a scanning subsystem. The reader initially attempts to acquire a symbol operating as a conventional imager. If unsuccessful, the reader then attempts to acquire a symbol operating as operating as a conventional scanner. If unsuccessful, the reader then employs an image sensor array of the imaging subsystem along with a scanning beam produced by the scanning subsystem, operating as a neither a conventional imager nor a conventional scanner.

### CROSS-REFERENCE TO RELATED APPLICATION

This application claims the benefit under 35 U.S.C. § 119(e) of U.S. Provisional Patent Application No. 60/711,027, filed Aug. 24, 2005.

### BACKGROUND OF THE INVENTION

1. Field of the Invention

This disclosure generally relates to the field of automatic data collection (ADC), and more particularly to machine-readable symbol readers operable to read machine-readable symbols, for example, barcode symbols, area or matrix code symbols and/or stack code symbols.

2. Description of the Related Art

Machine-readable symbol readers are generally categorized into two groups: 1) scanners, and 2) imagers. Each group has its own relative advantages.

Scanners typically move or scan a focused colliminated beam light sequentially across a target. The scanner may, for example, employ a laser source such as a semiconductor laser diode. While it may be possible to move the light source itself, scanners typically employ a scanning mechanism to move the beam of light sequentially across the target. The scanning mechanism may, for example, comprise one or more movable mirrors, reflectors or prisms and a motor to drive the mirror, reflector or prism. The motor typically rotates or pivotally oscillates the mirror, reflector or prism, which reflects the laser beam in a sweeping pattern back and forth across a target, thereby sequentially illuminating portions of the target along a scan line. Scanners also typically include an optoelectronic sensor, for example a photodetector or photodiode. The scanner may employ a means such as a standard lens or retro-collector to focus the returned light on the photodetector. The photodetector is a single light sensitive element that detects the light coming from a moving spot scanning beam returned from the target and produces a corresponding time domain analog signal. The scanner, or an associated device, converts an the analog signal into a digital signal, before decoding the digital signal according to standard decoding schemes. Scanners are particularly suited to reading linear or “one-dimensional” machine-readable symbols, such as barcode symbols in which information is encoded in the width of bars and spaces of the symbol. Scanners may also be well suited for reading in the far field, particularly when an axicon or other non-bezel lens is employed. However, laser scanners are particularly power consumptive devices. This may be particularly problematic for portable devices.

Imagers typically employ a one- or two-dimensional image sensor array to produce an image of the target, for example a one- or two-dimensional array of charge coupled devices (CCDs). The CCD array or Active Pixel Sensor (APS) may be electronically sampled to produce a digital signal suitable for decoding. While imagers may in some situations rely on ambient light, most imagers employ an illumination system. The illumination system may, for example, include a number of high intensity light emitting diodes (LEDs) arranged to simultaneously flood the entire target machine-readable symbol with light. Imagers strive for uniform illumination over the entire machine-readable symbol. Imagers may also include a lens system to focus light returned from the target onto the image sensor array. Imagers advantageously eliminate moving parts, and allow high reading speeds at relatively low cost. Imagers are particularly suited for reading two-dimensional symbols such as area or matrix code symbols. Imagers are well suited for near field reading, but may have limited range and/or depth-of-field as compared to scanners.

Some machine-readable symbol readers have been proposed that employ a combination of both scanning and imaging components. Such proposed readers appear to allow the choice between scanning and imaging to be based on the type of symbol to be acquired (i.e., one-dimensional versus two-dimensional).

There is a need in ADC arts for a machine-readable symbol reader that employs a sophisticated approach to choosing between scanning and imaging. There is a further need in ADC arts for a machine-readable symbol reader that employs a combination of elements of both scanning and imaging to improve the ability to capture machine-readable symbols in difficult conditions that might not otherwise be successfully acquired.

### BRIEF SUMMARY OF THE INVENTION

In one embodiment, a processor-readable medium stores instructions for causing a machine-readable symbol reader to read machine-readable symbols, by: determining if a level of light received from a target exceeds an intensity threshold; attempting to process information captured by an image sensor array without the aid of a scanning beam, if the level of light received from the target exceeds the intensity threshold; attempting to process information captured by a light sensitive element with the aid of the scanning beam, if the level of light received from the target does not exceed the intensity threshold; and attempting to process information captured by a portion of the image sensor array with the aid of the scanning beam, if the attempt to process information captured by a light sensitive element with the aid of the scanning beam is unsuccessful.

In another embodiment, a method of operating a machine-readable symbol reader to read machine-readable symbols comprises: determining whether a level of light received at an image sensor array from a target exceeds an intensity threshold; in response to determining that the light received at the image sensor array does not exceed the intensity threshold, emitting a scanning beam of light from the machine-readable symbol reader toward the target; receiving light including at least a portion of the scanning beam of light returned from the target; and attempting to decode information modulated in the received light including the scanning beam of light returned from the target.

In yet another embodiment, a machine-readable symbol reader operable to read machine-readable symbols, comprises: an image sensor array; a scanning subsystem operable to emit a scanning beam of light from the machine-readable symbol reader; a photodetector; at least one processor coupled to receive information captured by the image sensor array and the photodetector and coupled to control the scanning subsystem, the at least one processor operable to, at various times, determining if a level of light received from a target exceeds an intensity threshold; attempt to process information captured by the image sensor array without the aid of the scanning subsystem, if the level of light received from the target exceeds the intensity threshold; attempt to process information captured by a light sensitive element with the aid of the scanning subsystem, if the level of light received from the target does not exceed the intensity threshold; and attempt to process information captured by a portion of the image sensor array with the aid of the scanning subsystem, if the attempt to process information captured by a light sensitive element with the aid of the scanning mechanism is unsuccessful.

### BRIEF DESCRIPTION OF THE SEVERAL VIEWS OF THE DRAWINGS

In the drawings, identical reference numbers identify similar elements or acts. The sizes and relative positions of elements in the drawings are not necessarily drawn to scale. For example, the shapes of various elements and angles are not drawn to scale, and some of these elements are arbitrarily enlarged and positioned to improve drawing legibility. Further, the particular shapes of the elements as drawn, are not intended to convey any information regarding the actual shape of the particular elements, and have been solely selected for ease of recognition in the drawings.

FIG. 1 is a functional block diagram of a machine-readable symbol reader employing an image sensor array and a scanning mechanism to read a machine-readable symbol and to communicate with a destination device, according to one illustrated embodiment.

FIG. 2 is a flow diagram of a method of operating the machine-readable symbol reader of FIG. 1, according to one illustrated embodiment.

FIG. 3A is a schematic view illustrating a portion of the method of FIG. 2, in particular FIG. 3A illustrates the reading of a machine-readable symbol using the image sensor array without the aid of a scanning mechanism.

FIG. 3B is a schematic diagram illustrating a portion of the method of FIG. 2, in particular FIG. 3B illustrates the reading of a machine-readable symbol using a photodetector with the aid of the scanning mechanism.

FIG. 3C is a schematic diagram illustrating a portion of the method of FIG. 2, in particular FIG. 3C illustrates the reading of a machine-readable symbol using a portion of the image sensor array with the aid of the scanning mechanism.

### DETAILED DESCRIPTION OF THE INVENTION

In the following description, certain specific details are set forth in order to provide a thorough understanding of various disclosed embodiments. However, one skilled in the relevant art will recognize that embodiments may be practiced without one or more of these specific details, or with other methods, components, materials, etc. In other instances, well-known structures associated with machine-readable symbol readers, scanning mechanisms, lasers, imagers, processors including microprocessors, digital signal processors (DSPs), application specific integrated circuits (ASICs) or the like, and/or memories have not been shown or described in detail to avoid unnecessarily obscuring descriptions of the embodiments.

Unless the context requires otherwise, throughout the specification and claims which follow, the word “comprise” and variations thereof, such as, “comprises” and “comprising” are to be construed in an open, inclusive sense, that is as “including, but not limited to.”

Reference throughout this specification to “one embodiment” or “an embodiment” means that a particular feature, structure or characteristic described in connection with the embodiment is included in at least one embodiment. Thus, the appearances of the phrases “in one embodiment” or “in an embodiment” in various places throughout this specification are not necessarily all referring to the same embodiment. Further more, the particular features, structures, or characteristics may be combined in any suitable manner in one or more embodiments.

The headings provided herein are for convenience only and do not interpret the scope or meaning of the embodiments.

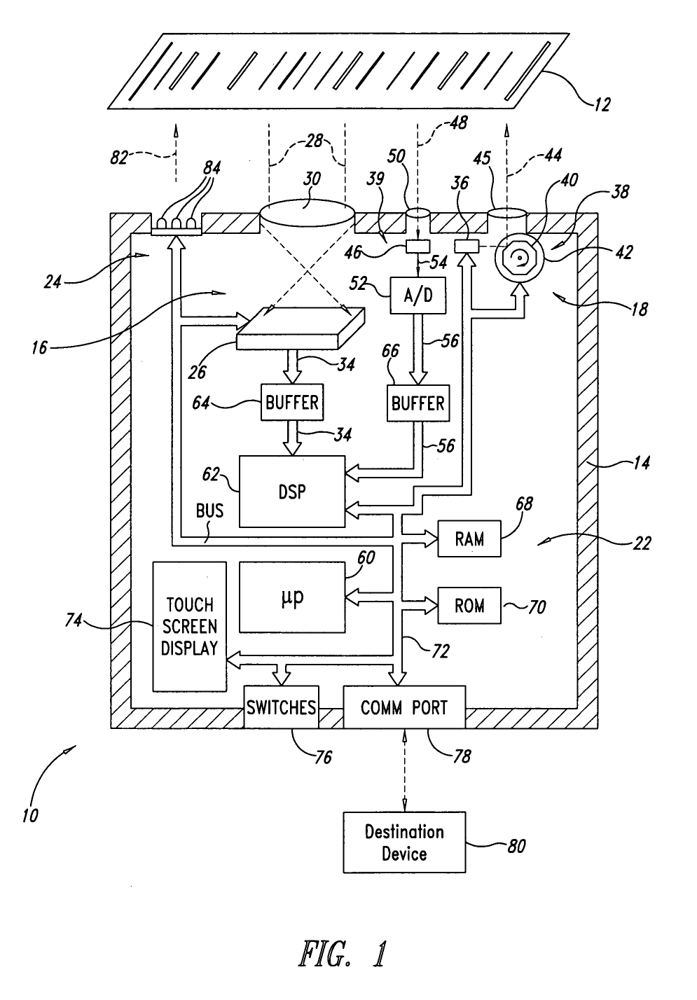

FIG. 1 shows a machine-readable symbol reader 10 positioned to read a target machine-readable symbol 12, for example a bar code symbol, area or matrix code symbol, or stack code symbol. The machine-readable symbol reader 10 may include a housing 14 that houses an imaging subsystem 16, scanning subsystem 18, control subsystem 22, and optionally illumination subsystem 24.

The imaging subsystem 16 includes an image capture device, for example, an image sensor array 26 such as a one- or two-dimensional array of CCDs. The image sensor array 26 is operable to transform an image received as light 28 returned from the target machine-readable symbol 12 into digital image data 34, for example one or more electrical signals. The imaging subsystem 16 may include one or more optical elements 30 positioned to focus the light 28 on the image sensor array 26. The optical elements 30 may, for example, include one or more lenses, mirrors, reflectors, prisms, or detractors.

The scanning subsystem 18 may include a light source 36, scanning mechanism 38 and photodetecting subsystem 39. The light source 36 may be operable to emit a collimated beam of light. The light source 36 may, for example, take the form of a laser light source such as a semiconductor laser diode. The scanning mechanism 38 may include a mirror, reflector or prism 40 and motor or other driver 42 drivingly coupled to rotate or pivot the mirror, reflector or prism 40 about an axis. The mirror, reflector or prism 40 may be polygonal, for example, including multiple facets. The scanning mechanism 38 is operable emit a scanning beam 44 from the housing 14 and to sequentially move the scanning beam 44 across the target machine-readable symbol 12. The scanning subsystem 18 may include one or more optical elements 45 to focus the scanning beam 44, for example to focus the scanning beam at infinity.

The photodetecting subsystem 39 includes a photodetector 46 positioned to receive modulated light 48 including the scanning beam 40 returned from the machine-readable symbol 12, and operable to transform the received modulated light 48 into an analog scan profile 54. The photodetecting subsystem 39 may include one or more optical elements 50 to collect and/or to focus the light 48 on the photodetector 46. The photodetecting subsystem 39 may also include an analog-to-digital converter 52 to convert the analog scan profile 54 into a digital scan profile 56.

The control subsystem 22 may include one or more controllers such as microprocessor 60, DSP 62, or ASIC (not shown). The control subsystem 22 may include one or more memories, for example an image buffer 64, a scan profile buffer 66, random axis memory (RAM) 68, and/or read-only memory (ROM) 70 coupled to the processors 60, 62 by one or more buses 72. While illustrated as a single bus 72 for clarity of the Figures, the control subsystem 22 may employ separate buses 72 for power, control and/or data. Where the machine-readable symbol reader 10 takes a hand-held form, power may be supplied from a battery, ultra-capacitor, fuel cell or other portable power source. The microprocessor 60 may execute instructions stored in RAM 68 and/or ROM 70 to control the operation of various elements of the machine-readable symbol reader 10. For example, microprocessor 60 may control the operation of the motor or driver 42 and/or laser 36 to produce the scanning beam 44. Additionally, or alternatively, the microprocessor 60 may turn the image sensor array 26 ON and OFF. The DSP 62 may be operable to decode digital image data 34 received from the image sensor array 26 and/or digital scan profiles 56 received from the photodetector 46.

The control subsystem 22 may further include user input/output (I/O) devices to allow the user to control operation of the machine-readable symbol reader 10, and to provide information to the user. For example, the control subsystem 22 may include a touch screen display 74 coupled to the microprocessor 60. The touch screen display 74 may display information to the user, for example indications of a successful symbol acquisition and/or successful decode. The touch screen display 74 may also allow the user to make various selections. For example, the touch screen display 74 may allow the user to turn ON or OFF the machine-readable symbol reader 10, the imaging subsystem 16 and/or the scanning subsystem 18. Additionally, or alternatively, the control subsystem 22 may include one or more user-operable switches 76 coupled to the microprocessor 60. The user-operable switches 76 may, for example, allow the user to turn ON or OFF the machine-readable symbol reader 10, the imaging subsystem 16 and/or the scanning subsystem 18. The control subsystem 22 may also include one or more speakers (not shown) to provide aural indications to the user.

The control subsystem 22 may further include a communications port 78 operable to provide wired and/or wireless communications, for example with a destination device 80. Wired communications may be over a serial or parallel signal path. Wireless communications may be over a radio frequency (RF) signal path and/or optical signal path such as via infrared signals. The destination device 80 may be a device external to the machine-readable symbol reader 10, for example a host computing system. Alternatively, the destination device 80 may take the form of a communications network or element of a communications network external to the machine-readable symbol reader 10, for example a server or a client. In some embodiments, the destination device 80 may be a peripheral device coupled to the machine-readable symbol reader 10, for example a storage medium such as a hard disk or flash memory. In other embodiments, the destination device 80 may be housed as part of the machine-readable symbol reader 10, for example a storage medium such as a PCMCIA card or the like.

The optional illumination subsystem 24 may include a number of illumination sources 84 positioned to emit light from the housing 14 in the general direction of the field-of-view of the image sensor array 26. The illumination sources 84 may take a variety of forms, for example, light emitting diodes (LEDs) and/or incandescent or fluorescent lights. The illumination sources 84 may operate in the visible portion of the electromagnetic spectrum and/or in invisible portions such as the infrared portion or ultraviolet portion. The microprocessor 60 is coupled to control the illumination subsystem 24. For example, the microprocessor 60 may be coupled to turn the illumination sources 84 ON and OFF and/or adjusting an intensity of illumination 82 provided by the illumination sources 84.

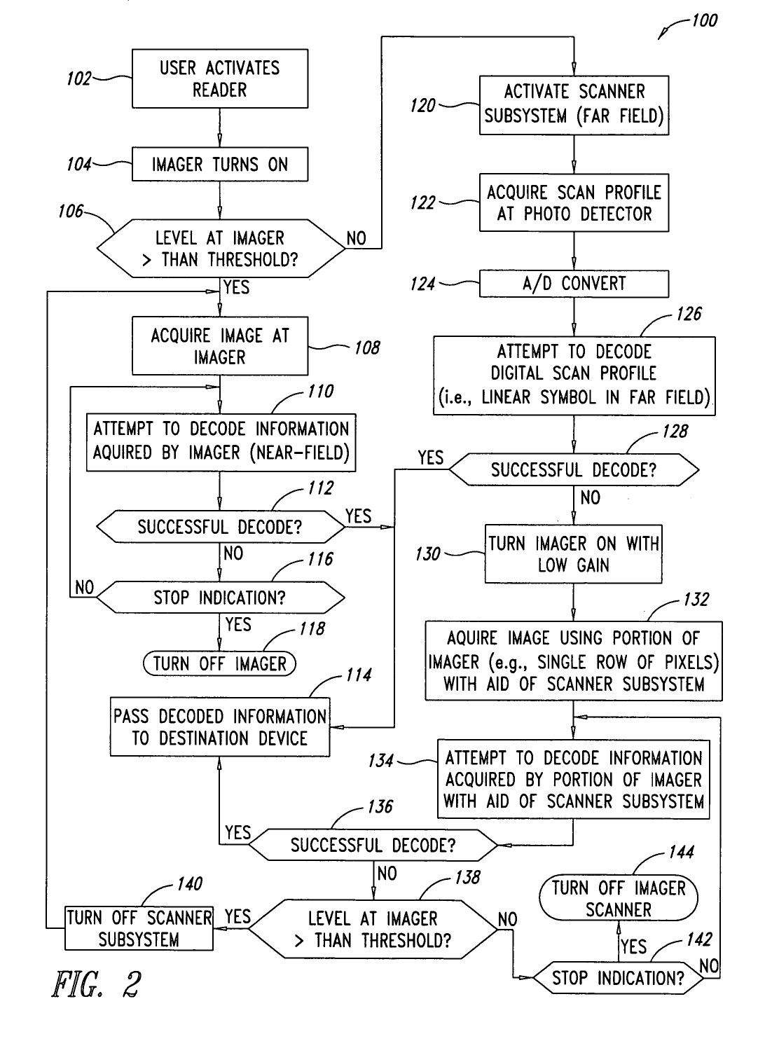

FIG. 2 shows a method 100 of operating the machine-readable symbol reader 10 according to one illustrated embodiment.

At 102, the user activates the machine-readable symbol reader 10, for example via the touch screen display 74 and/or switches 76. At 104, the microprocessor 60 places the image sensor array 26 in an active or ON state.

At 106, the microprocessor 60 determines whether the level of light received at the image sensor array 26 exceeds a threshold value. The microprocessor 60 may rely on a portion or all of the image sensor array to determine the level of light, or may employ a dedicated light sensor (not shown). If the level of light received at the image sensor array 26 exceeds the threshold value, control passes to 108 where the image sensor array 26 acquires an image via the returned light 28, producing a corresponding set of digital image data 34. The image buffer 64 may temporarily buffer the digital image data 34 until the DSP 62 is ready to process the digital image data 34.

At 110, the DSP 62 attempts to decode the digital image data 34 acquired by the image sensor array 26. At 112, the microprocessor 60 determines whether the attempt to decode the digital image data 34 was successful. If the digital image data 34 was successfully decoded, at 114 the microprocessor 60 passes the decoded information to the destination device 80.

If the attempted decode was not successful, the microprocessor 60 determines at 116 whether a stop indication has been received. The stop indication may be received, for example, from a user via the touch screen display 74 and/or switches 76. If a stop indication has been received, at 118 the microprocessor 60 deactivates or turns OFF the image sensor array 26. If a stop indication has not been received, control passes back to 110 and further attempts are made to decode the digital image data 34 produced by the image sensor array 26.

If the level of light received at the image sensor array 26 is determined at 106 to be below the threshold, control passes to 120 where the microprocessor 60 activates or turns ON the scanning subsystem 18. Activating or turning ON the scanning subsystem 18 may include activating or turning ON the light source 36, as well as providing signals to cause the motor or driver 42 to rotate or pivot the mirror, reflector or prism 40.

At 122, the photodetector 46 acquires the target machine-readable symbol 12 via the scanning beam 48 returned by the machine-readable symbol 12, and produces a corresponding analog scan profile 54. At 124, the A/D converter 52 converts the analog scan profile 54 into a digital scan profile 56. The scan profile buffer 66 may temporarily buffer the digital scan profile 56 until the DSP 62 is ready to process the digital scan profile 56.

At 126, the DSP 62 attempts to decode the digital scan profile 56. At 128, the microprocessor 60 determines whether the attempted decode of the digital scan profile 56 was successful. If attempted decode was successful, control passes to 114 where the microprocessor 60 passes the decoded information to the destination device 80.

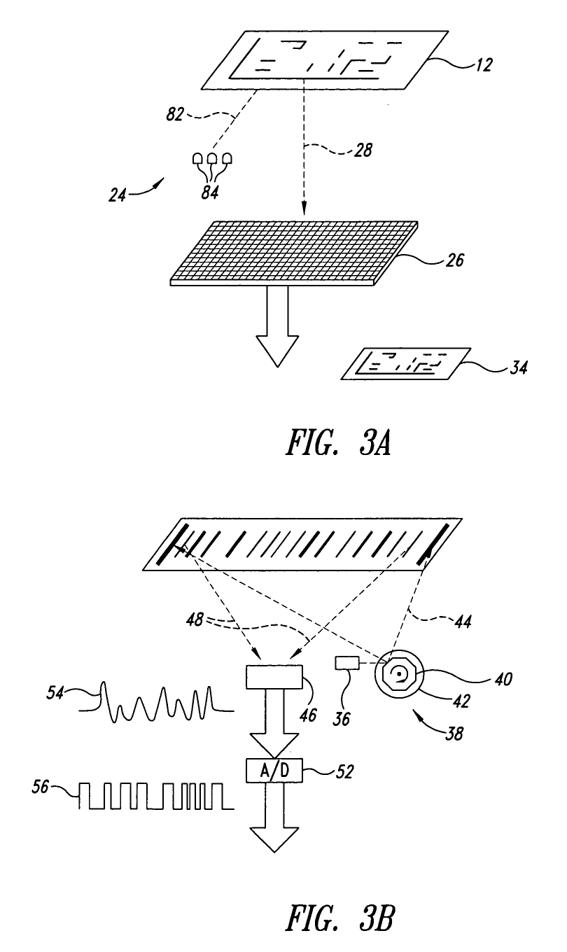

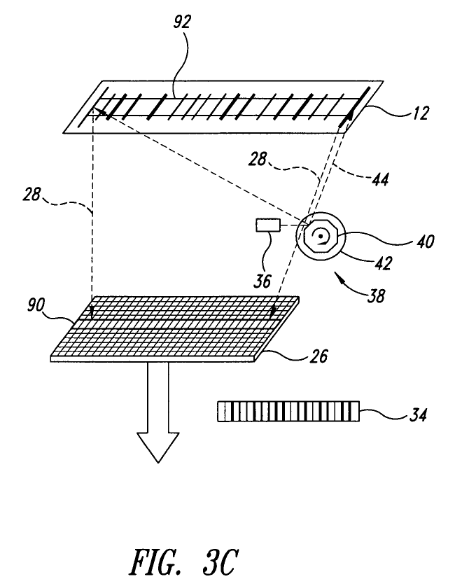

If the attempted decode was unsuccessful, at 130 the microprocessor 60 activates or turns ON the image sensor array 26, with low gain. At 132, the image sensor array 26 acquires an image using a portion 90 (FIG. 3C) of the image sensor array 26 by collecting light provided by one or more scans of the scanning subsystem 38. For example, as illustrated and discussed below, one or more rows of pixels (i.e., single addressable unit, e.g., one CCD element) of the image sensor array 26 may capture the image of a portion 92 (FIG. 3C) of the target machine-readable symbol 12 that is illuminated by the one or more passes of the scanning beam 44. Thus, a portion of the imaging subsystem 16 cooperatively operates with a portion of the scanning subsystem 18 to acquire a target machine-readable symbol 10, that might not otherwise be acquirable.

At 134, the DSP 62 attempts to decode the digital image data 34 acquired by the portion 90 (FIG. 3C) of the image sensor array 26 with the aid of the scanning subsystem 38. At 136, the microprocessor 60 determines whether the decode is successful. If the decode was successful, control passes to 114 where the microprocessor 60 passes decoded information to the destination device 80.

If the attempted decode was not successful, at 138 the microprocessor 60 determines whether the level of light received at the image sensor array 26 is greater than a threshold. This threshold can be the same as the previously referred to threshold, or in some embodiments may be a different threshold. If the level of light received at the image sensor array 26 is greater than the threshold, the microprocessor 60 deactivates or turns OFF the scanner subsystem 18 at 140, and returns control to 108.

If the level of light at the image sensor array 26 is not greater than the threshold, at 142 the microprocessor 60 determines whether a stop indication has been received. If a stop indication has been received, at 144 the microprocessor 60 deactivates or turns OFF the image sensor array 26 and the scanner subsystem 18. Otherwise, control passes back to 134, where the DSP 62 again attempts to decode the digital image data 34 acquired by the image sensor array 26.

FIG. 3A illustrates the image sensor array 26 capturing an image of the target machine-readable symbol 12 without the aid of the scanning subsystem 18. The image sensor array 26 may rely on ambient light and/or may rely on light 82 from the illumination subsystem 24. Thus, the machine-readable symbol reader 10 initially operates as a conventional imager employing the image sensor array 26 with ambient or flood illumination in an attempt to acquire a target machine-readable symbol which may be positioned in the near field.

FIG. 3B shows the photodetector 46 capturing an analog scan profile 54 of the machine-readable symbol 12 with the aid of the scanning subsystem 38. Thus, after operating as a conventional imager, the machine-readable symbol reader 10 then operates as a conventional scanner employing the photodetector 46 with a scanning beam 44 produced by the scanning subsystem 18 in an attempt to acquire a target machine-readable symbol 12 which may be positioned in the far field (e.g., >approximately 1.0 meters).

FIG. 3C shows a portion 90 of the image sensor array 26 capturing an image of a portion 92 of the machine-readable symbol 12 with the aid of the scanning subsystem 38. The scanning rate of the scanning beam 44 is sufficiently high or fast relative to the rate at which the image sensor array 26 is electronically sampled, such that the scanning beam 44 may appear to simultaneously illuminate the entire area or portion 92 of machine-readable symbol 12. Thus, where the distance (e.g., 50 cm) between the machine-readable symbol reader 10 and target machine-readable symbol 12 is so large that the laser spot would be too big to read, the image sensor array 26 detects a bright line extending across the portion 92 of the machine-readable symbol 12. The portion 90 of the image sensor array 26 may comprise a linear array of pixels, for example, a single row of pixels or several rows of pixels. Thus, after first operating as a conventional imager, then operating as a conventional scanner, the machine-readable symbol reader 10 finally operates as a neither a conventional imager nor a conventional scanner, employing the image sensor array 26 to spatially detect light returned from the scanning beam 44 produced by the scanning subsystem 18 in an attempt to acquire a target machine-readable symbol 12 which might not otherwise be acquired, such as one that may be positioned in the mid field.

Described above is a more sophisticated approach to choosing or selecting between imaging and scanning. The approach described above attempts to acquire and decode symbols using techniques suitable for the near field, followed by techniques suitable for the far field, which is then followed by techniques suitable for the mid field. The approach described above may advantageously employ a combination of elements of both the scanning and imaging subsystems to improve the ability to capture machine-readable symbols in otherwise difficult conditions.

The above description of illustrated embodiments, including what is described in the Abstract, is not intended to be exhaustive or to limit the invention to the precise forms disclosed. Although specific embodiments of and examples are described herein for illustrative purposes, various equivalent modifications can be made without departing from the spirit and scope of the invention, as will be recognized by those skilled in the relevant art. The teachings provided herein of the invention can be applied to other ADC devices, not necessarily the exemplary combination imaging and scanning machine-readable symbol reader 10 employing a motor drive mirror, reflector or prism generally described above. For instance, the scanning mechanism 38 may be implemented using micro-electro-mechanical system (MEMS) techniques to fashion the mirror, reflector or prism and driver mechanism or “motor” such as those disclosed in commonly assigned U.S. provisional application Ser. No. 60/583,406, filed Jun. 25, 2004 and U.S. nonprovisional application Ser. No. 11/ 149,452, filed Jun. 8, 2005. For example, as taught therein, a first reflective surface having a first perimeter creates a pointer beam, and a movable second reflective surface with a-second perimeter small than the first perimeter creates a scanning beam. The pointer and scanner beams may exists simultaneously and may be formed from a same illumination beam. Also for instance, the imaging subsystem 16 or other optical assemblies discussed above may employ a microfluidic lens assembly, such as that taught in commonly assigned U.S. patent application Ser. No. 11/040,485, filed Jan. 20, 2005 and U.S. provisional patent application Ser. No. 60/538,868 filed Jan. 23, 2004.

Also for instance, the foregoing detailed description has set forth various embodiments of the devices and/or processes via the use of block diagrams, schematics, and examples. Insofar as such block diagrams, schematics, and examples contain one or more functions and/or operations, it will be understood by those skilled in the art that each function and/or operation within such block diagrams, flowcharts, or examples can be implemented, individually and/or collectively, by a wide range of hardware, software, firmware, or virtually any combination thereof. In one embodiment, the present subject matter may be implemented via Application Specific Integrated Circuits (ASICs). However, those skilled in the art will recognize that the embodiments disclosed herein, in whole or in part, can be equivalently implemented in standard integrated circuits, as one or more computer programs running on one or more computers (e.g., as one or more programs running on one or more computer systems), as one or more programs running on one or more controllers (e.g., microcontrollers) as one or more programs running on one or more processors (e.g., microprocessors), as firmware, or as virtually any combination thereof, and that designing the circuitry and/or writing the code for the software and or firmware would be well within the skill of one of ordinary skill in the art in light of this disclosure.

In addition, those skilled in the art will appreciate that some of the mechanisms of taught herein are capable of being distributed as a program product in a variety of forms, and that an illustrative embodiment applies equally regardless of the particular type of signal bearing media used to actually carry out the distribution. Examples of signal bearing media include, but are not limited to, the following: recordable type media such as floppy disks, hard disk drives, CD ROMs, digital tape, and computer memory; and transmission type media such as digital and analog communication links using TDM or IP based communication links (e.g., packet links).

The various embodiments described above can be combined to provide further embodiments. All of the U.S. patents, U.S. patent application publications, U.S. patent applications, foreign patents, foreign patent applications and non-patent publications referred to in this specification and/or listed in the Application Data Sheet, including but not limited to U.S. Provisional Patent Application No. 60/711,027, filed Aug. 24, 2005, are incorporated herein by reference, in their entirety. Aspects of the invention can be modified, if necessary, to employ systems, circuits and concepts of the various patents, applications and publications to provide yet further embodiments of the invention.

These and other changes can be made to the invention in light of the above-detailed description. In general, in the following claims, the terms used should not be construed to limit the invention to the specific embodiments disclosed in the specification and the claims, but should be construed to include all ADC device structures or operations that accord with the claims. Accordingly, the invention is not limited by the disclosure, but instead its scope is to be determined entirely by the following claims.

We/I claim:

1. A processor-readable medium storing instructions for causing a machine-readable symbol reader to read machine-readable symbols, by:
determining if a level of light received from a target exceeds an intensity threshold;
attempting to process information captured by an image sensor array without the aid of a scanning beam, if the level of light received from the target exceeds the intensity threshold;
attempting to process information captured by a light sensitive element with the aid of the scanning beam, if the level of light received from the target does not exceed the intensity threshold; and
attempting to process information captured by a portion of the image sensor array with the aid of the scanning beam, if the attempt to process information captured by a light sensitive element with the aid of the scanning beam is unsuccessful.

2. The processor-readable medium of claim 1 wherein attempting to process information captured by a portion of the image sensor array with the aid of the scanning beam comprises:
sequentially illuminating portions of the target with the scanning beam at a rate higher than a rate at which the image sensor array is electronically sampled.

3. The processor-readable medium of claim 2 wherein attempting to process information captured by a portion of the image sensor array with the aid of the scanning beam further comprises:
electronically sampling a linear array of pixels of the image sensor array.

4. The processor-readable medium of claim 3 wherein electronically sampling a linear array of pixels of the image sensor array comprises:
electronically sampling a single row of pixels extending across a dimension of the image sensor array comprising a two-dimensional array of pixels.

5. The processor-readable medium of claim 1 wherein attempting to process information captured by an image sensor array without the aid of a scanning beam, if the level of light received from the target exceeds an intensity threshold comprises:
electronically sampling a two-dimensional array of pixels of the image sensor array while a scanning subsystem is not emitting the scanning beam from the machine-readable symbol reader.

6. The processor-readable medium of claim 1 wherein attempting to process information captured by a light sensitive element with the aid of the scanning beam, if the level of light received from the target does not exceed the intensity threshold comprises:
electronically sampling a photodetector while a scanning subsystem is emitting the scanning beam from the machine-readable symbol reader.

7. The processor-readable medium of claim 1 wherein attempting to process information captured by a light sensitive element with the aid of the scanning beam, if the level of light received from the target does not exceed the intensity threshold comprises:
electronically sampling a single pixel of the image sensor array while a scanning subsystem is emitting the scanning beam from the machine-readable symbol reader.

8. The processor-readable medium of claim 1 wherein determining if a level of light received from a target exceeds an intensity threshold comprises:
determining a level of light received by at least a single pixel of the image sensor array.

9. A method of operating a machine-readable symbol reader to read machine-readable symbols, the machine-readable symbol reader comprising an image sensor array and a scanner mechanism, the method comprising:
emitting a scanning beam of light from the machine-readable symbol reader toward a target;
receiving light including at least a portion of the scanning beam of light returned from the target; and
attempting to decode information modulated in the received light including the scanning beam of light returned from the target.

10. The method of claim 9, further comprising:
passing decoded information to a destination device if the attempt to decode information modulated in the received light including the scanning beam of light returned from the target is successful.

11. The method of claim 9, further comprising:
determining whether a level of light received at the image sensor array from the target exceeds an intensity threshold, wherein emitting a scanning beam of light from the machine-readable symbol reader toward the target is in response to determining that the light received at the image sensor array does not exceed the intensity threshold.

12. The method of claim 11, further comprising:
in response to determining that the light received at the image sensor array does exceed the intensity threshold, attempting to decode information modulated in the light received at the image sensor array without emitting a scanning beam of light from the machine-readable symbol reader toward the target.

13. The method of claim 12, further comprising:
passing decoded information to a destination device if the attempt to decode information modulated in the light received at the image sensor array without emitting a scanning beam of light from the machine-readable symbol reader toward the target is successful.

14. The method of claim 9, further comprising:
in response to a failure at attempting to decode information modulated in the received light including the scanning beam of light returned from the target, again emitting a scanning beam of light from the machine-readable symbol reader toward the target;
receiving light at a portion of the image sensor array including at least a portion of the scanning beam of light returned from the target; and
attempting to decode information modulated in the received light including the scanning beam of light returned from the target and received at only a portion of the image sensor array.

15. The method of claim 14 wherein the portion is a single row of pixels of the image sensor array.

16. The method of claim 14, further comprising:
determining whether a level of light received at the image sensor array from the target exceeds an intensity threshold; and
turning OFF the scanning beam of light if the level of light received at the image sensor array from the target exceeds an intensity threshold.

17. A machine-readable symbol reader operable to read machine-readable symbols, the machine-readable symbol reader comprising:
an image sensor array;
a scanning subsystem operable to emit a scanning beam of light from the machine-readable symbol reader;
a photodetector;
at least one processor coupled to receive information captured by the image sensor array and the photodetector and coupled to control the scanning subsystem, the at least one processor operable to, at various times,
determine if a level of light received from a target exceeds an intensity threshold;
attempt to process information captured by the image sensor array without the aid of the scanning subsystem, if the level of light received from the target exceeds the intensity threshold;
attempt to process information captured by a light sensitive element with the aid of the scanning subsystem, if the level of light received from the target does not exceed the intensity threshold; and
attempt to process information captured by a portion of the image sensor array with the aid of the scanning subsystem, if the attempt to process information captured by the light sensitive element with the aid of the scanning subsystem is unsuccessful.

18. The machine-readable symbol reader of claim 17 wherein the image sensor array comprises a two-dimensional array of charge coupled devices.

19. The machine-readable symbol reader of claim 17 wherein the scanning subsystem comprises at least one reflector mounted for movement about a rotational axis, and a laser source positioned to emit a laser light beam toward the reflector.

20. The machine-readable symbol reader of claim 17 wherein the at least one processor is operable to attempt to process information captured by a portion of the image sensor array with the aid of the scanning subsystem by:
causing the scanning subsystem to sequentially illuminate portions of the target with the scanning beam of light at a scanning rate; and
causing the image sensor array to electronically sample a linear array of pixels thereof at a sampling rate that is slower than the scanning rate.

21. The machine-readable symbol reader of claim 17 wherein the at least one processor comprises a first processor operable to control the scanning subsystem and a second processor dedicated to decoding information captured by the image sensor array and the photodetector.
